(19) United States
(12) Patent Application Publication
(10) Pub. No.: US 2017/0111243 A1
(43) Pub. Date: Apr. 20, 2017

(54) SYSTEMS AND METHODS FOR REAL TIME OR NEAR REAL TIME WIRELESS COMMUNICATIONS BETWEEN ELECTRONIC DEVICES

(71) Applicant: ENERGOUS CORPORATION, SAN JOSE, CA (US)

(72) Inventors: Douglas BELL, Pleasanton, CA (US); Michael A. LEABMAN, San Ramon, CA (US)

(21) Appl. No.: 15/060,819

(22) Filed: Mar. 4, 2016

Related U.S. Application Data
(63) Continuation-in-part of application No. 14/856,219, filed on Sep. 16, 2015.
(60) Provisional application No. 62/272,878, filed on Dec. 30, 2015.

(51) Int. Cl. H04L 12/26; H04W 4/00; H04W 24/08

(52) U.S. Cl. CPC H04L 43/022; H04W 24/08; H04W 4/008; H04L 43/14

(57) ABSTRACT

Disclosed herein are systems, methods, and devices using an improved wireless communications component that allows for real time or near-real time data sampling reporting between devices using modified wireless communications protocols (e.g., Bluetooth®, Wi-Fi), and real time or near-real time behavior adjustments by a first device based on the data samples received from a second device. Embodiments disclosed herein comprise devices, such as receivers and transmitters, having communications components that may communicate data samples, such as power values, in real time or near-real time, thereby allowing a first device (e.g., transmitter) to adjust in real time or near-real time operational behavior of the first device's hardware or software (e.g., adjust power waves) based upon the data samples (e.g., power values) received from a second device (e.g., receiver).

### CROSS-REFERENCE TO RELATED APPLICATIONS

This non-provisional application claims the benefit of U.S. Provisional Patent Application Serial No. 62/272,878, entitled “Systems And Methods For Real Time Or Near Real Time Wireless Communications Between Electronic Devices,” filed Dec. 30, 2015, which is incorporated by reference in its entirety.

This application is a continuation-in-part of U.S. patent application Ser. No. 14/856,219, entitled “Systems And Methods For Tracking Movement Of Receivers In A Transmission Field,” filed Sep. 16, 2015, which is incorporated by reference in its entirety.

### TECHNICAL FIELD

This application generally relates wireless communications between electronic devices, with exemplary applications in wireless power systems.

### BACKGROUND

There are many use cases for lightweight, low-energy wireless communications protocols, such as Bluetooth®, where the devices need to communicate in real time or near-real time. But often the demands for high rate communications between devices exceeds the capabilities of such wireless communications protocols, as they can often operate too slowly for real-time or near-real time communications.

In wireless charging, it would be beneficial for transmitters and receivers to communicate using low-energy wireless protocols, but it would also be beneficial if the transmitters and receivers could communicate in real time or near-real time. So messages instructing the transmitter how to formulate power waves must be received from the receiver with minimal lag time. However, Bluetooth® was not designed for such rapid communications. Bluetooth® requires senders and receivers to “take turns” responding or not responding, which is prohibitive to achieving or simulating real time or near real time communications. For example, a Bluetooth® client would normally send a request for a data item from a peripheral device and then waits until some data item is received or the Bluetooth® client determines that no response is going to be received.

Furthermore, even if there is a way to increase the rate at which a device could transmit data through a communications protocol, there are often limitations on the hardware responsible for the communications protocol. For example, communications components, such as Bluetooth® chipsets or a Wi-Fi network interface card (NIC), often comprise memory buffers configured to store protocol-specific messages containing the data intended to be transferred between devices. These buffers may be configured to fill and empty according to a predetermined data flow between the devices, according to the particular protocol. In such examples, the buffers may not be capable of allowing for one device or another to continuously transmit data without interruption, outside the normal operational patterns of the protocols. As such, the hardware and firmware of the devices may be limited in their respective communications rates, such that real time or near-real time data transfers are impractical if not impossible with existing lightweight wireless communications protocols.

What is needed is a means for reducing the overhead requirements on devices communicating via a low-energy or other lightweight communications protocol, such as Bluetooth®. What is needed is a means for adjusting or otherwise modifying the data flow between communications components (e.g., Bluetooth® chipsets, Wi-Fi NICs) over conventional communication protocols that would allow data packets or messages to be transmitted from one device to another in real time or near-real time. What is needed is a mechanism through which the limitation of memory buffers filling up and thereby preventing further communication can be removed.

### SUMMARY

Disclosed herein are systems and methods intended to address the shortcomings in the art and may provide additional or alternative advantages as well. Embodiments disclosed herein comprise devices, such as receivers and transmitters, having communications components that may communicate data samples, such as power values, in real time or near-real time, thereby allowing a first device (e.g., transmitter) to adjust in real time or near-real time operational behavior of the first device's hardware or software (e.g., adjust power waves) based upon the data samples (e.g., power values) received from a second device (e.g., receiver).

In an embodiment, a communications component of a first device comprises a processor configured to generate a first request for a data sample associated with a functional routine executed by a second device; and continuously and consecutively receive one or more data samples from the second device; and upon receiving from the second device at least one data signal comprising a flag bit: transmit a second request for a data sample associated with the functional routine executed by the second device.

In another embodiment, a communications component of a first device comprises: one or more memories configured to store one or more data messages containing data samples prior to transmission to a second device; and a processor configured to: continuously and consecutively generate the one or more data messages containing the one or more data samples; and upon determining that each of the one more memories are filled with one or more messages, transmit at least one data message containing an indicator that the one or more memories are full.

In another embodiment, a method comprises transmitting, by a communications component of a first device, to a second device a first request for one or more data samples associated with a functional routine of the second device; continuously and consecutively receiving, by the communications component of the first device, from the second device one or more data signals containing a data sample; and upon receiving from the receiver at least one data signal comprising a flag bit: transmitting, by the communications component of the first device, a second request for one or more data samples associated with the functional routine of the second device, the second request configured to cause the second device to reset one or more buffers of the communications component of the second device.

In yet another embodiment, a method comprises continuously and consecutively transmitting, by a communications component of a first device, to a second device one or more data samples generated from a functional routine executed by the first device; transmitting, by the communications component of the first device, to the second device at least one message comprising a flag bit upon determining that a set of one or more buffers of the communications component of the second device is unavailable; and resetting, by the communications component of the first device, the set of one or more buffers upon receiving a second request for the one or more data samples resulting from the functional routine.

In another embodiment, a method for wireless power transmission comprises continuously and consecutively receiving, by a communications component of a transmitter, one or more power messages from a receiver, each respective power message containing at least one power value associated with one or more power waves generated by the transmitter; upon receiving each consecutive power message, determining, by a processor of the transmitter, whether to adjust a characteristic of the one or more power waves based upon the at least one power value of the power message; and upon receiving at least one power message comprising a flag bit, transmitting, by the communications component of the transmitter, to the receiver a second request requesting the one or more power values.

In yet another embodiment, a transmitter device comprises a communications component configured to continuously and consecutively receive one or more power messages from a receiver, each respective power message containing at least one power value associated with or a measurement of one or more power waves generated by the transmitter, and the one or more power messages received via a communications signal independent of the one or more power waves; and a processor configured to: determine whether to adjust a characteristic of the one or more power waves based upon the at least one power value of each consecutive power message; and instruct the communications component to transmit to the receiver a request requesting the one or more power values associated with the one or more power waves, upon receiving at least one power message comprising a flag bit. The flag bit can be configured to instruct or otherwise trigger the transmitter to transmit a second request for one or more power values. In some embodiments, the flag bit received from the receiver can indicate that the receiver has no available output buffers or otherwise requests the transmitter to send the second request for the one or more power values.

In another embodiment, a method for wireless power transmission comprises receiving, by a communications component of a receiver, from a transmitter a first request for one or more power values associated with one or more power waves; continuously and consecutively transmitting, by the communications component of the receiver, one or more power messages containing a power value associated with the one or more power waves; and upon determining that a set of one or more buffers of the communications component of the receiver is unavailable: transmitting, by the communications component of the receiver, at least one message containing an indicator bit indicating that the set of one or more buffers are full or otherwise no another buffer is unavailable for transmission; and resetting, by the communications component of the receiver, at least one buffer memory in the set of one or more buffers of the communications component upon receiving a second request for one or more power values from the transmitter. In some embodiments, the communications component of the receiver may return from a transmission loop of continuously and consecutively transmitting power messages in order to allow or to otherwise cause the output buffers of the receiver to be reset.

In yet another embodiment, a wireless charging receiver device comprises a communications component comprising: a set of one or more buffer memories configured to store one or more power messages containing one or more power values; and a processor configured to continuously and consecutively transmit to a transmitter the one or more power messages until determining that the set of one or more buffer memories are filled, and upon determining that the set of one or more buffer memories are filled, transmit an indicator bit or flag to the transmitter and reset the set of one or more buffer memories in the receiver; and a processor configured to continuously and consecutively determine a power value associated with one or more power waves for each consecutive power message generated by the communication component of the receiver device.

It is to be understood that both the foregoing general description and the following detailed description are exemplary and explanatory and are intended to provide further explanation of the invention as claimed. Although some of the features and benefits of the current invention has been described in the context of wireless charging, it should be understood that the invention can be used in the context of any communication link, wired or wireless, where efficient and low power transmission of data is needed.

### BRIEF DESCRIPTION OF THE DRAWINGS

The accompanying drawings constitute a part of this specification and illustrate several possible embodiments. The present disclosure can be better understood by referring to the following figures. The components in the figures are not necessarily to scale, emphasis instead being placed upon illustrating the principles of the disclosure.

FIG. 1 shows components of a wireless power transmission system, according to an exemplary embodiment.

FIG. 2 shows steps of wireless power transmission, according to an exemplary method embodiment.

FIG. 3 shows the logical data flow for communications over a Bluetooth® communications signal, between a transmitter and a receiver, during a wireless power transmission process, according to an exemplary embodiment.

### DETAILED DESCRIPTION

Reference will now be made to exemplary embodiments illustrated in the drawings, and specific language will be used to describe the same. It will nevertheless be understood that no limitation on the scope of potential embodiments is intended. Other embodiments may be used and/or other changes may be made without departing from the spirit or scope of the present disclosure. The illustrative embodiments described in the Detailed Description are not meant to be limiting upon the subject matter presented herein.

Exemplary System and Method of Wireless Charging System

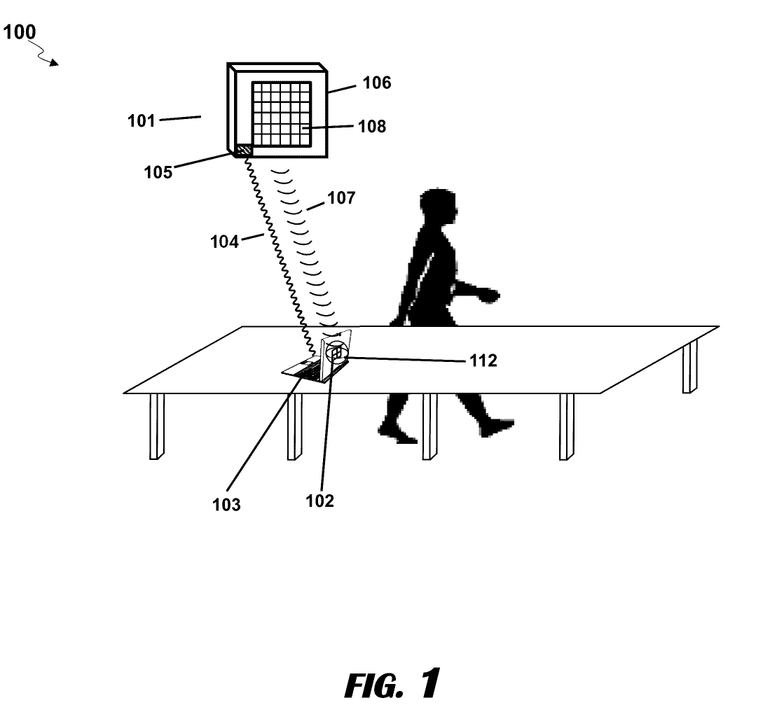

FIG. 1 shows components of a wireless power transmission system 100, according to an exemplary embodiment. The exemplary system 100 may comprise a transmitter 101 and a receiver 102 coupled to an electronic device 103. The transmitter 101 and receiver 102 may exchange information related to power waves, including information regarding the location of the receiver 102 within a transmission field and the amount of power being received by the receiver 102, and other forms of administrative information, through a communication signal 104. Based on the information gathered over communications signal 104, the transmitter 101 may generate and transmit one or more power waves 107 to the receiver 102, or some location proximate to the receiver 102, allowing the receiver 102 to gather energy from the power waves 107 and convert the energy into electrical current to power the electronic device 103.

A transmitter 101 may comprise an antenna array 106 having one or more antennas that may transmit power waves 107 into a transmission field, which may be a two or three-dimensional space where the transmitter 101 may provide power waves 107 to one or more receivers 102. In some instances, the transmitter 101 may generate and transmit power waves 107 having waveform characteristics (e.g., frequency, amplitude, trajectory, phase) that cause the power waves 107 to converge at a predetermined location in the transmission field to form constructive or destructive interference patterns. When enough power waves 107 accumulate constructively at a particular location, the resulting constructive interference pattern may form a pocket of energy 112. And when enough power waves accumulate destructively at a particular location, the resulting destructive interference pattern may form a null space in the transmission field. The targeted receiver 102 may comprise various circuitry configured to capture energy from a pocket of energy 112 and then convert the energy into useable power for the electronic device 103.

The transmitter 101 may comprise a communications component 105 that may effectuate wired and/or wireless communications to and from one or more receivers 102 of the system 100. In some embodiments, a communications component 105 may be an embedded component of the transmitter 101; and, in some embodiments, the communications component 105 may be attached to the transmitter 101 through any wired or wireless communications medium. In some instances, an attached communications component 105 may be shared among a plurality of transmitters 101, such that each of the transmitters 101 coupled to the communications component 105 may use the data received within a communications signal 104, by the communications component 105. The transmitter communications component 105 may comprise electromechanical components (e.g., processor, antenna) that allow the communications component 105 to communicate various types of data with corresponding receiver communications components (not shown) of one or more receivers 102. The transmitter communications component 105 may be configured to exchange communications signals 104 with the receiver communications component based on one or more wired or wireless communications protocols. Non-limiting examples of such protocols may include: Bluetooth®, Wireless Fidelity (Wi-Fi), Near-Field Communications (NFC), ZigBee, and others. It should be appreciated that the communications component 105 is not limited to radio-frequency based technologies, but may include radar, infrared, and sonic devices (e.g., ultrasound) for sonic triangulation, and may be used for determining the location, or other aspects, of a receiver 102.

The data contained within the communications signals 104 may be used by the transmitter 101 and/or the receiver 102 to determine how the transmitter 101 should generate and transmit, safe and effective power waves 107, from which the receiver 102 may capture energy and convert it to useable alternating current (AC) or direct current (DC) electricity, or other forms of energy. Using the communications signal 104, the transmitter 101 and receiver 102 may exchange data that may be used for various functions of the transmitter 101, such as: identifying receivers 102 within the transmission field; determining whether electronic devices 103 or users are authorized to receive power waves 107; determining safe and effective waveform characteristics for power waves 107; and honing or optimization of the placement of pockets of energy 112 in the transmission field with respect to the receivers 102, among other possible functions.

Similarly, a receiver communications component, which may be integrated into a receiver 102 or electrical device 103 as shown in FIG. 1, may use a communications signal 104 to communicate operational data with the communications component 105 of the transmitter 101, where such operational data may be used for various functions of the transmitter 101 or receiver 102, such as: alerting a transmitter 101 that the receiver 102 has entered, or is about to enter, into the transmission field of the transmitter 101; providing information about the user or the electronic device 103 being charged by the receiver 103, such as authentication data or a system profile; indicating the effectiveness of the power waves 107 or pocket of energy 112 in providing power to the receiver 102, such as a power level conversion or reception indicator; and providing updated transmission parameters for the transmitter 101 to use to adjust the power waves 107 to form more effective pockets of energy 112 or null spaces (not shown), among other types of useful data. Moreover, the communications component 105 of the transmitter 101 and the receiver communication component may communicate different types of data (e.g., authentication data, heat-mapping data, transmission parameters) containing various types of information, message, and data points; non-limiting examples of possible information, messages, and data points may include: a transmitter identifier (transmitter ID), a receiver identifier (receiver ID), a Bluetooth® unique identifier (Bluetooth ID), a beacon message, a device identifier (device ID) for an electronic device 103, a user identifier (user ID), the battery level for the electronic device 103, the receiver's 102 location in the transmission field, and the electronic device's 103 location in the transmission field, among a number of other possible types of information, messages, and/or data points.

The antenna array 106 may be a set of one or more antennas 108 configured to transmit power waves 107 into the transmission field of the transmitter 101. Integrated circuits (not shown) of the transmitter 101, such as a controller circuit and/or waveform generator, may control the behavior of the antennas 108. For example, based on the information received from the receiver 102 via the communications signal 104, a controller circuit may determine a set of waveform characteristics (e.g., amplitude, frequency, trajectory, phase) for generating power waves 107 that would effectively provide power to the receiver 102 and electronic device 103. The controller circuit may also identify a subset of antennas 108 from the antenna array 106 that would be effective in transmitting the power waves 107. As another example, a waveform generator circuit of the transmitter 101 coupled to the controller may convert energy and generate the power waves 107 having the waveform characteristics identified by the controller, and then provide the power waves 107 to the antenna array 106 for transmission.

In some implementations, an antenna 108 of the antenna array 106 may transmit power waves 107 having a set of characteristics that cause the power waves 107 to arrive at a given location within a transmission field and constructively or destructively accumulate as needed. For instance, when forming a pocket of energy 112, the antennas 108 of the antenna array 106 may transmit power waves 107 that intersect at a given location (usually at or nearby a detected receiver 102), and due to the respective characteristics of each of the power waves 107 generated by each respective antenna 108, the intersecting power waves 107 form a constructive interference pattern having enough energy to create a useful pocket of energy 112 from which the receiver 102 may collect energy and generate electric power. It should be appreciated that, although the exemplary system 100 describes radio-frequency based power waves 107, additional or alternative transmitter antennas, antenna arrays, and/or wave-based technologies may be used (e.g., ultrasonic, infrared, magnetic resonance) to wirelessly transmit power from the transmitter 101 to the receiver 102.

Receivers 102 may be used for powering or charging an associated electronic device 102 coupled to or integrated with one or more receivers 102. A receiver 102 may comprise one or more antennas (not shown) that may receive power waves 107 originating from one or more transmitters 101. In some implementations, the receiver 102 may receive power waves 107 transmitted directly from a transmitter 101; and, in some implementations, the receiver 102 may capture energy from the constructive interference pattern defining a pocket of energy 112 and formed from power waves 107. The pocket of energy 112 may be a three-dimensional field of energy resulting from the convergence of power waves 107 at a location in the transmission field.

The receiver 102 may comprise circuitry (not shown) configured to capture energy from a pocket of energy 112 or power waves 107, and then convert that energy into electricity useable by the electronic device 103. Non-limiting examples of such circuits may include a controller-processor integrated circuit, an amplifier, a rectifier, and a voltage conditioner, among others. After the power waves 107 are received and/or energy is gathered from a pocket of energy 112, the receiver's 102 circuitry (e.g., integrated circuits, amplifiers, rectifiers, voltage conditioner) may convert the energy of the power waves 107 (e.g., radio frequency electromagnetic radiation) to electric power (i.e., electricity), which may be stored into a battery (not shown) or used by an electronic device 103.

As previously mentioned, a receiver 102 or an electronic device 103 may comprise a receiver-side communications component (not shown) configured to communicate various types of data with the transmitter 101 in real-time or near real-time, through a communications signal 104 generated by the receiver-side communications component. The data may include location indicators for the receiver 102 and/or electronic device 103, and a power status of the device 103, status information for the receiver 102, status information for the electronic device 103, status information for the power waves 107, and/or status information for the pockets of energy 112. In other words, the receiver 102 may provide real time or near-real time data to the transmitter 101, via the communications signal 104, regarding the current operation of the system 100, including: the present location the receiver 102 or the device 103, the amount of energy received by the receiver 102, and the amount of power received and/or used by the electronic device 103, among other possible data points containing other types of information.

As mentioned, in some implementations, the receiver 102 may be integrated into the electronic device 103, such that, for all practical purposes, the receiver 102 and electronic device 103 may be understood to be a single unit or product; but, in some embodiments, the receiver 102 may be permanently or detachably coupled to the electronic device 103 at some point after production of the receiver 102 and electronic device 103. It should be appreciated that the receiver 102 may be configured to use the communications component of the electronic device 103, and/or the receiver 102 may comprise a communications component that is independent of the electronic device 103.

An electronic device 103 coupled to a receiver 102 may be any electronic device 103 that requires continuous power, or that draws stored power from a battery (not shown). The receiver 102 may be permanently integrated into the electronic device 103, or the receiver 102 may be permanently or detachably coupled to the electronic device 103. Non-limiting examples of electronic devices 103 may include laptops, mobile phones, smartphones, tablets, music players, toys, batteries, flashlights, lamps, electronic watches, cameras, gaming consoles, appliances, GPS devices, and wearable devices or so-called “wearables” (e.g., fitness bracelets, pedometers, smart watch), among other types of electrical devices 121.

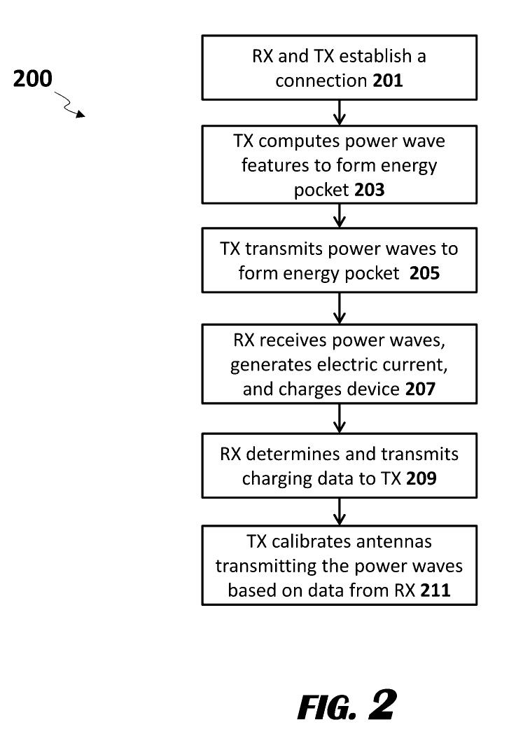

FIG. 2 shows steps of wireless power transmission, according to an exemplary method 200 embodiment. The exemplary method 200 comprises steps 201, 203, 205, 207, 209, and 211. However, it should be appreciated that other embodiments may include additional or alternative steps, or may omit one or more steps of the exemplary method 200 shown in FIG. 2, but may nevertheless fall within the scope of this disclosure.

In a first step 201, a transmitter (TX) and receiver (RX) establish a connection or otherwise associates with one another according to a particular wireless communication protocol. Transmitters and receivers may communicate operational data containing various operational data values and/or operational instructions using a communications signal, according to a wireless communication protocol capable of transmitting data between communications components of electrical devices (e.g., Bluetooth®, Bluetooth Low Energy (BLE), Wi-Fi, NFC, ZigBee®). Some protocols require devices to associate with one another in order to conduct various protocol-specific handshakes, authentication protocols, and other potential administrative data exchanges. For example, to communicate using a Wi-Fi based communications signal, the transmitter may function as a wireless access point requiring the receiver to be authenticated, both the transmitter and receiver may need to be authenticated to a standalone wireless access point.

As another example, in embodiments implementing Bluetooth®, or Bluetooth® variants, a Bluetooth-enabled communications component of a transmitter may scan for receivers indirectly broadcasting advertisement signals, or the transmitter may receive an advertisement signal from the transmitter. The advertisement signal may announce the receiver's presence to the transmitter, and may trigger an association between the transmitter and the receiver. As described herein, in some embodiments, the advertisement signal may communicate information that may be used by various devices (e.g., transmitters, client devices, sever computers, other receivers) to execute and manage pocket-forming procedures. Information contained within the advertisement signal may include a device identifier (e.g., MAC address, IP address, UUID), the voltage of electrical energy received, client device power consumption, and other types of data related to power transmission. The transmitter may use the advertisement signal to identify the receiver and, in some cases, locate the receiver in a two or three-dimensional space. Once the transmitter identifies the receiver, the transmitter may establish the Bluetooth connection thereby associating the transmitter with the receiver and allowing the transmitter and receiver to communicate operational data via communications signals.

In a next step 203, the transmitter may use the advertisement signal to determine a set of characteristics for power waves that would effectively establish a pocket of energy at or near the receiver. Non-limiting examples of features of power waves may include phase, gain, amplitude, power level, frequency, and trajectory, among others. The transmitter may use information contained in the receiver's advertisement signal and subsequent communications signals in order to gather the data needed to determine the effective waveform characteristics for producing and transmitting power waves.

In a next step 205, after the transmitter determines the appropriate waveform characteristics for the power waves, the transmitter may begin generating and transmitting power waves. As the power waves are transmitted, their respective characteristics may cause them to converge at a predetermined location in a transmission field, resulting in a constructive interference pattern that forms a pocket of energy at or near the location of the receiver. An antenna of the receiver may capture or otherwise receive energy from the energy field resulting from the constructive interference pattern that defines the pocket of energy.

In a next step 207, the receiver may capture or otherwise receive the electrical energy directly from the power waves or from a pocket of energy defined by a constructive interference pattern resulting from the constructive accumulation of converging power waves. As previously mentioned, the receiver may comprise circuitry configured to convert the energy captured from the constructive interference patterns into electrical current that may power an electrical device coupled to receiver, such as a laptop computer, smartphone, battery, toy, or other electronic device. In some embodiments, an AC/DC converter may convert the electrical energy from AC-current into DC-current, or from DC-current into AC-current. In embodiments where the circuitry of the receiver generates AC-current from the power waves, the receiver may comprise a rectifier circuit that may rectify the AC-current in order to provide usable DC-current to the electronic device coupled to the receiver.

In a next step 209, the receiver may generate operational data containing information indicating the effectiveness of the power waves or pocket of energy. This operational data may then be communicated to the transmitter through the communications signal, using a particular wireless protocol (e.g., Bluetooth®, Wi-Fi, ZigBee, NFC, RFID). When generating the operational data, the receiver may identify and/or process data points and other information useful for instructing the transmitter on generating and transmitting, or otherwise adjusting, the power waves. Non-limiting examples of data points and other types of information that may be included in the operational data or may be used to generate the operational data, may include: the quality of the power waves, the quality of the battery charge or quality of the power reception, the location or motion of the receiver, the power levels (e.g., amount of voltage) received and converted by the receiver, and/or the amount of power used by the electronic device. As an example, the receiver may determine how much energy the antenna of the receiver is receiving from the power waves or pocket energy, how much energy the receiver is converting into electric power, the amount of electric power the receiver is providing to the electronic device, and/or the power consumption or requirements of the electronic device, among others.

In operation, as the transmitter continuously transmits the power waves, the receiver may be continuously generating and transmitting operational data containing information related to the effectiveness of the power waves, and providing this data via the communications signal to the transmitter in real time or near-real time. The operational data may inform the transmitter how to generate and transmit, or otherwise adjust, the power waves to provide effective or improved wireless-charging service to the receiver. The communications signals may be transmitted and received independent from the power waves, using a wireless protocol capable of communicating operational data between the transmitter and receiver, including BLE, NFC, Wi-Fi, and the like.

In a next step 211, the transmitter may calibrate or otherwise adjust the characteristics of the power waves and/or the antennas transmitting the power waves, so that the antennas transmit power waves having a more effective set of waveform characteristics (e.g., trajectory, frequency, phase, gain, amplitude). In some embodiments, a processor of the transmitter may automatically determine more effective features for generating and transmitting the power waves based on the operational data received from the receiver via the communications signal.

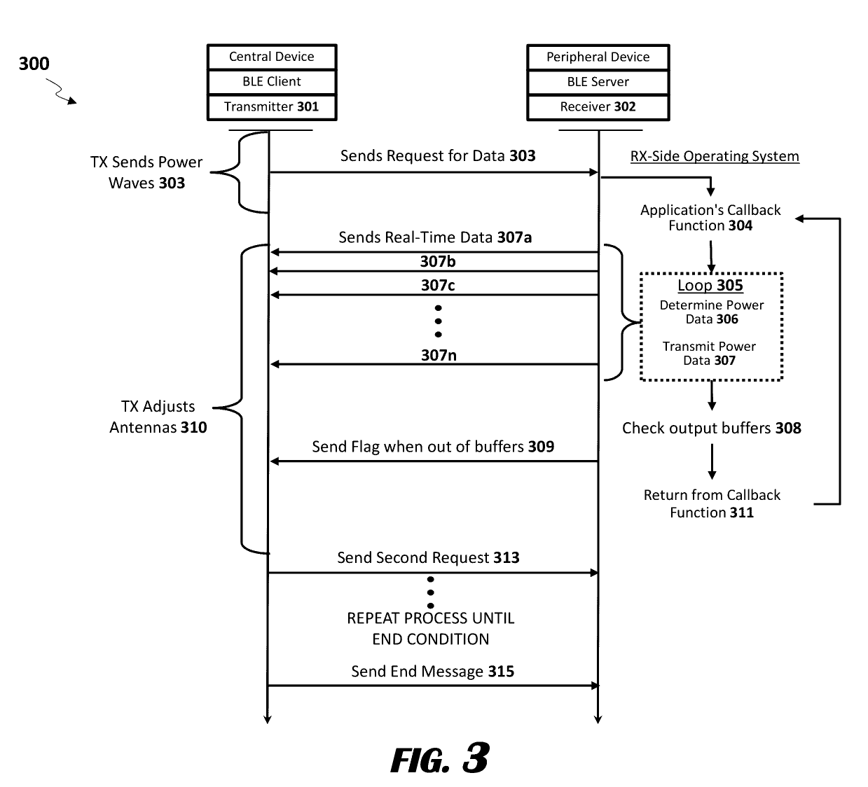

FIG. 3 shows the logical data flow for communications over a Bluetooth® communications signal, between a transmitter 301 and a receiver 302, during a wireless power transmission process 300, according to an exemplary embodiment. In the exemplary embodiment, the transmitter 301 and receiver 302 may comprise improved communications components, which may expand upon the features and capabilities of conventional hardware and software components used to send and receive a communications signal, such as a Bluetooth® processor and antenna. The improved communications components may be configured to send and receive real time or near-real time operational data that may be used by the transmitter 301 for power wave generation and transmission, thereby allowing the transmitter 301 to adjust the antennas and power waves in real time or near-real time. The improved communications components may be configured to communicate the operational data through communications signals using known communications protocols, such as Bluetooth®. However, the communication components may be configured to communicate the operational data through conventional protocols in a way that conventional communications components were previously incapable, and which were regularly discouraged by the art, to accomplish results that were previously believed to be impossible. The improved communications components permit the receiver 302 to transmit the operational data via the communications signals in real time or near-real time to the transmitter 301, thereby allowing the transmitter 301 to adjust the power waves in real time or near-real time accordingly.

As previously mentioned, the transmitter 301 and receiver 302 may communicate operational data that informs the transmitter 301 how to generate safe and effective power waves. The transmitter 301 may periodically or continuously adjust the antennas to produce power waves differently, based upon the operational data received back from the transmitter 302. It is desirable for the transmitter 301 to be able to minimize the amount of energy that is transmitted in the proximity of a person through further adjustments, to minimize the time needed to adjust the power waves when a person is in power wave transmission path, and to adjust the power waves to maintain the most effective and/or efficient power waves possible. These goals can be better addressed when the transmitter 301 and receiver 302 are communicating real time or near-real time operational data, to allow for real time or near-real time transmit antenna adjustments. To facilitate real time or near-real time transmit antenna adjustments, the transmitter 301 needs to receive operational power data from the receiver 302 in real time or near-real time. Conventional communications components are ordinarily limited with regards to allowing the receiver to 302 to determine and report operational data to the transmitter 301 fast enough for the transmitter 301 to adjust the antennas in real time or near-real time. The exemplary embodiment shown in FIG. 3 addresses such limitations by allowing the communications component of the receiver 302 to transmit real time or near-real time operational power data to the transmitter 301.

It should be appreciated that the exemplary embodiment described in FIG. 3 is not limited to practice in wireless power transmission processes. One having skill in the art would appreciate that any number of alternative embodiments may exist where a first device (e.g., transmitter 301) and a second device (e.g., receiver 302) communicate wirelessly, and where the first device polls or otherwise requests the second device to report data in real time or near-real time so that the first device may likewise adjust operations in real time or near-real time.

In a first step 303, a transmitter 301 may transmit power waves to a receiver 302 and may also transmit a request for the receiver 302 to report back power data or other operational data. The devices 301, 302 may comprise communications components configured to communicate the power data via a communications signal using a wireless communications protocol, such as Bluetooth®. In some cases, before transmitting the power waves, the transmitter 301 may be associated with the receiver 302 according to the operational rules of the communications protocol. Before, during, or after transmitting the power waves, the transmitter 301 may transmit a request for the receiver 302 to report the power data or other operational data. In some implementations, this request may instruct, or may otherwise trigger, the receiver 302 to execute an operating system function, software application, or other software or firmware routine that generates and reports back power data indicating the effectiveness of the power waves.

In a next step 304, when the receiver 302 receives from the transmitter 301 the power waves and/or the Bluetooth® message requesting the power data, the receiver 302 may execute a software “callback” function for continuously determining the power data and transmitting the power data to the transmitter 301.

In a next step 305, upon executing or triggering the callback function, the receiver 302 enters into a recurring loop during which, among other possible actions, the callback function of the receiver 302 may determine in a next step 306 the power data based on the power waves received from the transmitter 301, and then in a following step 307 may transmit the power data to the transmitter 301. This power data may be determined by hardware devices that measure the voltage and current from the receiver antenna array, and report the voltage and current, or their resultant power product to the receiver's processor. In addition, before returning to the beginning of the loop, the communications component of the receiver 302 determines, in a subsequent step 308, whether there are any available output buffers for transmitting additional outbound messages to the transmitter 301.

In a next step 306, the callback function of the receiver 302 may determine one or more types of power level data based on efficacy of the power waves captured or otherwise received by the receiver 302. Non-limiting examples of power data may include the amount of RF energy received or otherwise captured by the antennas of the receiver 302, the amount of RF energy the receiver is converting or has converted to AC or DC, and how much power is required by an electronic device or battery coupled to the receiver 302, charge level of the battery of the device, among other types of power data. Further explanation and examples of how such power level data may be determined and transmitted to the transmitter 301 can be found in U.S. patent application Ser. No. 14/856,219, entitled “Systems And Methods For Tracking Movement Of Receivers In A Transmission Field,” filed Sep. 16, 2015, which is incorporated by reference in its entirety. The callback function of the receiver 302 may determine power data for a given moment or continuously for a certain time period. As the receiver 302 determines the power data at a given instant, the receiver 302 may then populate one or more output buffers of the communications component with the power data determined for the given instant. The output buffers may be a volatile memory component of the communications component of the receiver 302 that may store wireless messages prepared by the receiver 302. In some implementations, the output buffers may function as a first-in-first-out (FIFO) memory that temporarily stores wireless messages to be transmitted to the communications component of the transmitter 301, such that the output buffers operate as a queue for wireless messages containing the power data as the power data is generated.

In a next step 307, after determining the power level for a given instant or time period, the receiver 302 may transmit to the transmitter 301 the power data recently stored into the output buffers. In some cases, the wireless messages containing the power data may be transmitted as the power data is generated, which provides for faster response times for the transmitter 301 to adjust the antennas. In some cases, the wireless messages may be placed into an output buffer and may be transmitted when the output buffer is filled. This may slow the process 300 slightly, but may be useful for providing more information to the transmitter 301. As seen shown in FIG. 3, the communications component of the receiver 302 may transmit a power data to the transmitter 301 each interval through the loop 305, and thus the receiver may continuously determine power value data and then transmit to the transmitter 301 consecutive power messages 307a-n containing each consecutive power value determination.

In a next step 308, after each respective power message is transmitted 307a-n to the transmitter via the communications signal, a processor of the communications component of the receiver or the processor of the receiver may determine whether the output buffers of the communications component are filled or used. A communications component of the receiver may comprise a predetermined number of output buffers and/or a predetermined output buffer size, where an output buffer may be a volatile memory location that temporarily stores messages to be outputted and/or messages that were recently outputted. The communications component may determine the number of available output buffers and/or the number of buffers currently occupied, which is ordinarily zero or otherwise very few at the beginning of the process 300. As each successive power message is generated and transmitted, the output buffers are filled, which could eventually prohibit generation and transmission of additional power messages to the transmitter because ultimately no output buffer would be available.

When output buffers are not filled or are otherwise available, the loop 305 continues, back to previous step 306, to determine one or more power values.

During execution of the loop 305, the transmitter 301 may perform a set of steps 310, in which the transmitter adjusts the antennas transmitting the power waves based upon the power value data received in the successive power messages. In some implementations, the transmitter 301 may determine whether to adjust the power waves to more accurately converge and form constructive interference at or near the receiver 302, when the power levels reported back from the receiver 302 fail to satisfy a power level threshold. The power level threshold may be predetermined and stored in memory of the transmitter 301 or may be received as a power value from the receiver, acting on behalf of an electronic device coupled to the receiver 302. The power waves may converge at the location due to the waveform characteristics used to generate and transmit the power waves, and in some cases, due to which antennas are used to transmit the one or more power waves. In order to adjust and better transmit the power waves, the transmitter 301 may use the power values received from the receiver 302 to identify whether the adjustments are needed, and then to determine which characteristics should be adjusted. For example, the receiver may report that too much power is being received, and thus the receiver may determine that a lower amplitude, or fewer power waves are needed.

It should be noted that such adjustments of the antennas in real time or near-real time would not be feasible using conventional communications components, such as Bluetooth® chips and related firmware, because such conventional devices are unable to continuously and consecutively transmit data messages to the receiver as the data messages are being produced. In addition, the conventional communications components would not be capable of overcoming the limitations of the output buffers. Although it is contrary to conventional wisdom, communications components may be configured to execute loop 305, which may bypass conventional handshakes and/or other overhead processes associated with the particular wireless protocol and/or incorporate a mechanism to reset the buffers when they are determined to be filled, thereby permitting the receiver 302 to generate and transmit to the transmitter 301 power messages containing power data at nearly the same instant the power data is produced.

In a next step 309, after determining that the output buffers are filled, the communications component of the receiver may transmit a power message containing an indicator or flag bit to the transmitter 301. The power message containing the flag bit may or may not contain power value data or other operational data, or may only contain the flag bit. The flag bit may indicate that the buffers of the receiver are filled, or may otherwise instruct the transmitter to transmit a new request for power values. One having skill in the art would appreciate that rather than just one flag bit, one or more bits may be used to indicate that buffers are filled or unavailable, or to otherwise trigger the transmitter 301 to transmit a new request for power values. One or more flag or indicator bits may also be transmitted between the transmitter 301 and receiver 302 to trigger other behaviors, such as requesting that the transmitter 301 stop transmitter power waves, or instructing the receiver 302 to reset the output buffers of the receiver communications component. It should be appreciated that the terms “flag bit,” “flag bits,” “indicator bit,” and “indicator bits” are used interchangeably herein, and may comprise one or more binary data bits configured to instruct or otherwise trigger hardware and/or software behavior by the device intended to receive the one or more binary data bits.

In a next step 311, the communications component of the receive 302 may reset the memory address of the memory buffers or may purge the data stored in the memory buffers, or otherwise make the buffers again available to output messages from receiver to transmitter, and may then return to a ready state for the call back function, as in previous step 304.

In a next step 313, when the transmitter 301 receives the indicator or flag bit from receiver 302, the transmitter may automatically transmit a new request for power data and/or other operational data. The process 300 may then repeat until the receiver no long requires power waves from the transmitter 301 or there is some other break in the wireless association of the devices.

The process 300 may continue to repeat until an ending condition is detected or is otherwise identified by the transmitter 301. One skilled in the art may recognize that there may be any number of ending conditions that may be recognized by either the transmitter or the receiver. However, for ease of description in the exemplary embodiment, the transmitter 301 may be configured to stop the power transmission process 300 for the receiver 302 when the transmitter 301 receives a signal from the receiver 302 indicating that the receiver 302 no longer needs power or when the receiver 302 is physically moved beyond the range of the power waves or the communications signals of transmitter 301.

As another example, a receiver 302 may send a message, indicator or flag bit, or some other signal to the transmitter 301 requesting the end of power transmission. In this example, the receiver 302 may automatically determine that no further power is required, or a user may operate a software application that instructs the receiver 302 to transmit an end-request. As another example, the transmitter 301 may decide to end power transmission when the receiver 301 or user has exceeded an authorized amount of energy, or an application monitoring operations of a wireless power transmission system comprising the transmitter 301 may instruct the transmitter 301 to end the power transmission process 300.

In a next step 315, after the transmitter 301 determines to stop transmitter power waves due to an end condition, the transmitter 301 may then send through the communications signal a special message with a flag bit or other indicator bit that signals to receiver 302 to stop sending power data messages to transmitter 301. In some implementations, the receiver 302 may cease operations, and in some implementations, the receiver 302 application or software module may return from the callback function to ready state, as in previous step 311.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” and the like, are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

What is claimed is:

1. A communications component of a first device, the communications component comprising:
a processor configured to:
generate a first request for a data sample associated with a functional routine executed by a second device;
continuously and consecutively receive one or more data samples from the second device; and
upon receiving from the second device at least one data signal comprising a flag bit:
transmit a second request for a data sample associated with the functional routine executed by the second device.

2. The communications component of the first device according to claim 1, wherein the second request is configured to cause the second device to reset one or more output buffer memories of the communications component of the second device.

3. The communications component of the first device according to claim 1, further comprising an antenna configured to transmit a data signal containing the request for the data sample to the second device.

4. The communications component of the first device according to claim 1, further comprising an antenna configured to continuously and consecutively receive one or more data signals containing the one or more data samples from the second device.

5. The communications component of the first device according to claim 1, wherein the processor of the communications component is further configured to transmit each consecutive data sample to a device processor of the first device.

6. The communications component of the first device according to claim 5, wherein the device processor executes one or more software applications based upon each consecutive data sample transmitted by the processor of the communications component.

7. The communications component of the first device according to claim 1, wherein the first device is a wireless power transmitter.

8. The communications component of the first device according to claim 1, wherein the second device is a wireless power receiver.

9. The communications component of the first device according to claim 1, wherein the communications component of the first device comprises one or more chips configured to communicate using a Bluetooth® wireless communications protocol.

10. A communications component of a first device, the communications component comprising:
one or more memories configured to store one or more data messages containing data samples prior to transmission to a second device; and
a processor configured to:
continuously and consecutively generate the one or more data messages containing the one or more data samples; and
upon determining that each of the one more memories are filled with one or more messages, transmit at least one data message containing an indicator that the one or more memories are full.

11. The communications component of the first device according to claim 10, wherein the processor is further configured to reset the one or more memories upon receiving a second request for a data sample from the second device.

12. The communications component of the first device according to claim 10, wherein the processor is further configured to store each consecutively generated data message into a memory upon generating the data message containing the data sample.

13. The communications component of the first device according to claim 10, wherein the processor is further configured to transmit the first request for the data sample to a software module executed by the second device and configured to generate each consecutive data sample for each consecutive data message.

14. The communications component of the first device according to claim 13, wherein the processor is further configured to instruct the software module to halt generation of each data sample upon determining that the one or more memories are filled.

15. The communications component of the first device according to claim 14, wherein the processor is further configured to instruct the software module to generate a next data sample for a next data message upon receiving a second request for the next data sample from the second device.

16. The communications component of the first device according to claim 10, further comprising an antenna configured to receive a data signal containing one or more requests for one or more data samples.

17. The communications component of the first device according to claim 10, wherein the communications component of the first device comprises one or more chips configured to communicate using a Bluetooth® wireless communications protocol.

18. The communications component of the first device according to claim 10, wherein the first device is a wireless power receiver, and wherein the second device is a wireless power transmitter.

19. A method comprising:
transmitting, by a communications component of a first device, to a second device a first request for one or more data samples associated with a functional routine of the second device;
continuously and consecutively receiving, by the communications component of the first device, from the second device one or more data signals containing a data sample; and
upon receiving from the second device at least one data signal comprising a flag bit:
transmitting, by the communications component of the first device, a second request for one or more data samples associated with the functional routine of the second device, the second request configured to cause the second device to reset one or more buffers, of the communications component of the second device.

20. A method comprising:
continuously and consecutively transmitting, by a communications component of a first device, to a second device one or more data samples generated from a functional routine executed by the first device;
transmitting, by the communications component of the first device, to the second device at least one message comprising a flag bit upon determining that a set of one or more buffers of the communications component of the first device is unavailable; and
resetting, by the communications component of the first device, the set of one or more buffers of the communications component of the first device upon receiving from the second device a second request for one or more data samples resulting from the functional routine.
